(19) United States
(12) Patent Application Publication
(10) Pub. No.: US 2020/0271070 A1
(43) Pub. Date: Aug. 27, 2020

(54) METHOD FOR ACCELERATING FOULING OF INJECTORS IN GASOLINE DIRECT INJECTION ENGINES AND FOR EVALUATING PERFORMANCE OF DEPOSIT CONTROL ADDITIVES

(71) Applicant: REPSOL, S.A., Madrid (ES)

(72) Inventors: Javier ARÍZTEGUI CORTIJO, Móstoles Madrid (ES); Fermín OLIVA MIÑANA, Móstoles Madrid (ES)

(21) Appl. No.: 16/061,977

(22) PCT Filed: Dec. 14, 2016
(86) PCT No.: PCT/EP2016/081081

§ 371 Date: Jun. 13, 2018

(30) Foreign Application Priority Data
Dec. 15, 2015 (EP) 15382628.4

(51) Int. Cl. F02D 41/38; C10G 75/00; C10L 1/02; F02D 41/02; F02M 65/00; F02B 77/04

(52) U.S. Cl. CPC F02D 41/38; C10G 75/00; C10L 1/023; F02D 41/0235; F02M 65/008; F02B 77/04; F02D 2200/101; C10L 2270/023; C10G 2300/104; C10G 2300/1044; C10G 2300/201; C10G 2300/4075; C10L 2200/0423

(57) ABSTRACT

A method for fouling an injector of a gasoline direct injection engine, includes the steps of operating the direct injection engine on at least a first stationary engine mode which is defined by a pre-established engine load and a pre-established engine speed. Both the pre-established engine load and the speed are within 35% and 65% of their maximum values, this at least first stationary engine mode being characterized by high particulate matter generation. The direct injection engine is operated on the at least first engine mode for less than ten hours.

A method for evaluating the fouling effect of a gasoline formulation in a gasoline direct injection engine uses the above-described fouling method.

### TECHNICAL FIELD

The present disclosure is related to the formation of deposits on fuel injectors and the methods to evaluate such deposit formation.

### BACKGROUND

Fuels are chemically unstable products, especially with high temperatures and/or with the presence of oxygen. Usually the degradation of the fuel produces high molecular hydrocarbons or carbonaceous materials, which are retained on the surfaces. Depending on where the deposits are retained the effects on engine performance are more or less significant.

The effect of fuel deposits on engine performance has changed over the years associated to the technological evolution of the fuel system used. Some years ago, the most common technology in vehicles was port fuel injection (PFI). In these vehicles, fuel injected in the intake manifold impinges the hot surface of the intake valves, undergoing degradation and forming deposits on the valve surface (which grow incrementally). These deposits may affect the control of the fuel delivery system impacting on engine performance, especially in acceleration phases.

There are some standard test methods for measuring or evaluating the fouling of the intake valves in such port fuel injection engines (Stepien Z., Oleksiak S., “Deposit forming tendency in spark ignition engines and evaluation of gasoline detergent additives effectiveness”, Journal of KONES Powertrain and Transport, Vol. 16, No. 2, 2009). For instance, the engine tests methods CEC F-20-98 or CEC F-05-93. These test methods are usually based on the formation of a fuel layer on the intake valve, and letting the fuel to degrade by dehydrogenation under certain thermal conditions.

But nowadays, the most common technology used by European vehicle manufacturers is fuel direct injection since it increases the thermal efficiency of the engine. In this case, the most important fouling does not take place on the intake valves, but rather on at the injector holes. The fouling of injector holes modifies the fuel delivery pattern in the combustion chamber and the way air and fuel mix, increasing particulate matter emissions and disturbing optimal engine performance. Due to the reduction of the cross section area of injector holes, the flow through them is reduced. This in turn requires an increase of the injection duration so as to deliver enough fuel to ensure the same engine power output. In the Electronic Control Unit (ECU) of the engine some parameters are employed to modify the fuel injection duration due to the injector fouling. Measuring the evolution of these parameters with time provides an idea of how the fouling process is advancing. This feature is used by some researchers to propose tests which cause injector fouling and follow the process by registering ECU parameters (Scott Smith S., Imoehl W., “Measurement and control of fuel injector deposits in direct injection gasoline vehicles”. SAE Technical paper 2013-01-2616. 2013; DuMont R. J. et al “Test and control of fuel injector deposits in direct injected spark ignition vehicles”, SAE Technical paper 2009-01-2641. 2009). However, due to the lack of precision of these measurements, they are not the optimal solution for correctly evaluating injector fouling. Alternatively, instead of following the evolution of the ECU parameters, it is possible to measure the instantaneous injection timing and duration with a clamp meter and an encoder and obtain substantially more precise results.

Injectors used in Gasoline Direct injection (GDI) engines have also undergone an evolution to minimize injector fouling (and optimize air-fuel mixture). Initially injectors were designed with one hole and they were made of one material. Nowadays injectors usually have 5 to 6 calibrated orifices, which are drilled in a specific material to reduce the carbonaceous material deposition over the injector surface. However, this solution is not completely effective to solve injector fouling in GDI engines.

Another common solution to control the formation of deposits, associated to fuel degradation in the engine, is to incorporate Deposit Control Additives (DCA) to the fuel, which are composed by detergent or dispersant molecules. These molecules avoid the surface deposition and growth of the carbonaceous products. The performance of DCAs depends on its formulation. Also DCAs are more or less effective depending on the fuel injection system and intake system design. Another consideration is related with the DCA quantity necessary to reduce or eliminate the fouling problem of GDI injectors. An excessive quantity of additives reduces the fouling tendency of injector holes (as will be appreciated below in FIGS. 6 and 7), but may generate combustion chamber deposits, which may cause problems due to the generation of hot points inside the cylinder and a possible knocking tendency (finally damaging the engine).

Despite the knowledge about injector fouling in GDI engines, there is no standard test procedure for evaluating or measuring the formation of deposits on the injector of new gasoline engines with direct injection systems, in a similar way to the standard engine tests used in port fuel injector engines for evaluating deposits on the intake valves. Some researchers have proposed to use the standard test for intake valves cleanliness (or similar procedures) to evaluate injector fouling in GDI engines, achieving long time fouling periods (Von Bacho P. S. et al. “Engine test for accelerated fuel deposit formation on injectors used in gasoline direct injection engines”. SAE Technical paper 2009-01-1495, 2009). Other researchers have developed a specific test on a chassis dynamometer based on a vehicle following typical city and road conditions with a duration of 48 hours (cf. documents from Scott Smith S and from DuMont R, J. cited above). Or other researchers proposed to work at very severe conditions (stationary mode close to maximum load), achieving a 16-hour test with a first generation (year 2003) direct injection engine (with first generation injector technology which promotes injector fouling) (China P., Rivere J., “Development of a direct injection spark ignition engine test for injector fouling”. SAE Technical paper 2003-01-2006. 2003). These testing conditions do not guarantee optimal injection fouling conditions in GDI engines. Thus, there is a need for a new procedure for evaluating injector deposits formation and the effects of detergent additives (DCA) to ensure an optimum engine performance in new vehicles.

### SUMMARY

In order to avoid the problems presented in the previous section, the present disclosure proposes a method for evaluating, in a short period of time (less than 10 hours, and preferably around 6 hours), the amount of injector deposits in a controlled way, thereby enabling the measurement of the effectiveness of deposit control additives to keep clean (or clean up) fuel injectors in Gasoline Direct Injection (GDI) engines. This 6-hour methodology also supports development procedures, allowing testing every single day, for example, any change in the formulation of fuel, additive used, engine parameter or injector design.

A first aspect of the present disclosure refers to a method for fouling an injector of a gasoline direct injection engine, which comprises:
operating the direct injection engine on at least a first stationary engine mode which is defined by a pre-established engine load and a pre-established engine speed, the pre-established engine load and speed being comprised within 35% and 65% of their maximum values, this at least first stationary engine mode being characterized by high particulate matter generation; wherein the direct injection engine is operated on at least first engine mode for less than ten hours.

Establishing operation of the GDI engine as defined above, in which the GDI engine is operated on at least an engine mode with engine load and speed within 35% and 65% of their maximum values, provides high generation of particulate matter, which in turn creates injector fouling very rapidly and it is possible to evaluate the injector fouling of injectors in less than 10 hours. This process is done with a thermally stable engine. In some embodiments the GDI engine is operated on at least an engine mode with engine load and speed within 40% and 60% of their maximum values, further guaranteeing the high generation of particulate matter, which in turn accelerates injector fouling.

By high particulate matter generation it is understood when the concentration of particulate matter in the exhaust gases is above 30% of the maximum concentration of particulate matter of the engine in the exhaust gases. The method of the disclosure preferably further comprises:

a) determining the maximum concentration of particulate matter of the gasoline direct injection engine in the exhaust gases, for example, by performing a full screening of an engine map preferably with a non-additivated gasoline with an injector used for more than 50 hours; and,
b) establishing high particulate matter generation as a concentration of particulate matter in the exhaust gases that is above a 30% of the maximum concentration of particulate matter determined in step a).

In preferred embodiments, operating the direct injection engine comprises alternating operation of the direct injection engine between selected engine modes, preferably a first stationary engine mode and a second stationary engine mode, each engine mode being defined by a pre-established engine load and a pre-established engine speed, both the pre-established engine load and speed being comprised within 35% and 65% of their maximum values, and both stationary engine modes having high particulate generation but at the same time being thermally stable or stationary (remaining in the same condition or state).

The disclosure preferably further comprises continuously monitoring the injection duration of the injector using external current measuring means, such as a clamp meter and an angle encoder. Preferably, the disclosure further comprises continuously monitoring the particulate matter emission.

By establishing operation of the GDI engine as defined above—alternating between two engine modes with high generation of particulate matter—, and by preferably analysing the evolution of the injection duration and/or the evolution of particulate emissions, it is possible to evaluate the injector fouling of injectors in less than 10 hours, preferably for less than 8 hours, and more preferably in just 6 hours.

The use of two stationary modes with high particulate matter generation in the accelerated fouling test minimizes the effect of non-controlled parameters (such as base fuel formulation). Then, the test fouling cycle provides stronger results, because it covers the main region of influence where the particulate matter generation and deposition is higher.

In some embodiments the GDI engine starts operating at the engine mode having the highest engine load, in order to ensure that the particulate generation is high enough to foul the injector.

The direct injection engine is operated in the first engine mode and in the second engine mode preferably during predefined time intervals, these time intervals preferably having the same duration for both modes. Each time interval has a duration of at least 1 minute to guarantee the stabilization of the engine parameters and, in particular, of the particulate emission, making it a stationary condition. The duration of each interval is preferably 15 minutes.

In preferred embodiments, temperatures and pressures at pre-established points of the engine are continuously monitored. This ensures the reproducibility of the method of the disclosure, and at the same time allows detecting possible erratic fluctuations of the engine due the corrections applied by the ECU of the engine, and thereby discarding the corresponding measurements on injection duration and particulate matter emission.

Another aspect of the present disclosure is a method for evaluating the fouling effect of a gasoline formulation in a GDI engine, which comprises using the method for fouling an injector of any of the previous descriptions and operating the gasoline direct injection engine with such gasoline formulation. This gasoline formulation may include deposit control additives, whose performance can be evaluated.

The effect of different component designs (for example, fuel delivery pattern), engine design (for example, air dynamics in the intake system) or engine parameters (for example, fuel injection timing and pressure) on injector fouling can also be evaluated using the method for fouling an injector of the present disclosure, and operating the gasoline direct injection engine with different component designs, or different engine designs or different values of the engine parameters.

Indeed, the method for acceleratedly fouling injectors of the present disclosure is useful to evaluate the effect of different fuel formulations, fuel additives or another parameter on injector fouling in a short period of time.

The different aspects and embodiments of the disclosure defined in the foregoing can be combined with one another, as long as they are compatible with each other.

Additional advantages and features of the disclosure will become apparent from the detailed description that follows and will be particularly pointed out in the appended claims.

### BRIEF DESCRIPTION OF THE DRAWINGS

To complete the description and in order to provide for a better understanding of the disclosure, a set of drawings is provided. Said drawings form an integral part of the description and illustrate an embodiment of the disclosure, which should not be interpreted as restricting the scope of the disclosure, but just as an example of how the disclosure can be carried out. The drawings comprise the following figures:

FIG. 1 schematically shows a preferred embodiment of test bench prepared for evaluating fouling of injectors.

FIGS. 2 and 3 schematically show an example of a test cycle followed by the GDI engine, in terms of the engine speed and load, respectively.

FIG. 4 schematically shows the difference in the injection duration as an example of fouling during a test cycle of a clean injector.

FIG. 5 schematically shows the evolution of the injection duration using four different formulations in the test cycle.

FIG. 6 schematically shows the evolution of particulate matter emissions using four different formulations in the test cycle.

FIG. 7 shows a graphic comparison of the 6-hour fouling test according to the disclosure and a non-accelerated 29-hour test in terms of particulate emission.

FIG. 8 schematically shows an analysis of the repeatability of the method of the disclosure (seven repetitions performed with the same commercial fuel and under the same conditions).

### DETAILED DESCRIPTION OF THE DRAWINGS

The following description is not to be taken in a limiting sense but is given solely for the purpose of describing the broad principles of the disclosure. Embodiments of the disclosure will be now described by way of example, with reference to the above-mentioned drawings showing elements and results according to the disclosure.

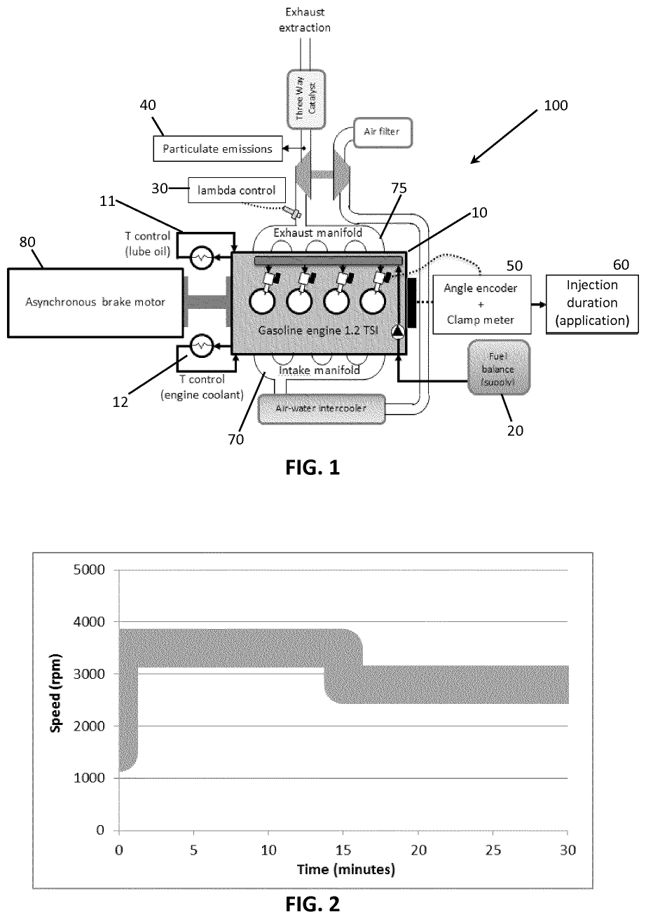

The method for fouling injectors of the present disclosure is performed using a gasoline direct injection (GDI) engine 10 in a test bed 100, as schematically shown in FIG. 1. In this specific example, the engine installed on the test bed is a 1197 cm3 GDI engine coded EA111 by the Volkswagen Group. The engine has a power of 77 kW, maximum torque of 175 Nm, maximum speed of 5700 rpm and has two valves per cylinder.

The test bed installation 100 shown in FIG. 1 is formed by:
an electric dynamometer 80 to brake the engine 10, controlled by an automatic system to ensure better engine control and reproducibility;
a lubricating oil recirculating system with temperature (T) control 11;
a refrigeration liquid recirculating system with temperature (T) control 12;
different pressure and temperature sensors to measure and control the engine performance during the test:
   ambient conditions (pressure and temperature);
   pressure and temperature at intake manifold;
   pressure and temperature at exhaust manifold;
   pressure and temperature after Three-Way Catalyst (TWC);
   lubricating oil temperature;
   refrigeration liquid temperature;
   injection pressure;
a fuel balance module 20;
a lambda measurement module 30 (to check that the test is carried out with lambda substantially equal to 1); and
particulate matter emission analysing equipment 40.

The test bed installation 100 further comprises two clamp meters and an angle encoder with resolution of 0.1 ° CA (crank angle degrees) (block 50 in FIG. 1), so as to measure the activation signal of the injectors of cylinders one and three. The output of this block is introduced in an application 60 which measures with high precision the injection pulse duration (pulse width) in each cylinder. The deviation of the original injector pulse width is used for measuring and quantifying the amount of deposits on the injector holes.

As also shown in FIG. 1, the engine 10 is connected to the corresponding intake and exhaust manifolds 70 and 75 in order to provide fresh air and dispose exhaust gases respectively. The remaining elements in this FIG. 1 are an air-water intercooler 85 to control the intake air temperature, an air filter 90 to eliminate any particle from the intake air and a three-way catalyst 95 to control pollutant emissions from the engine.

The method of the present disclosure can be carried out in this test bed, controlled by the electric dynamometer and controlling the fluid temperatures during the test cycle (lubricating oil and refrigerant). The main parameters considered are:
Engine speed (rpm)
Engine load (Nm)
Particulate matter emissions (mg/m3)
Injection duration (° CA)

In order to define the operation modes of the engine for the method, an initial screening of the engine map is carried out. In these screening, operation modes with a high emission of particles are identified. Typically, these engine conditions are defined in terms of engine speed (measured in rpm) and engine torque (measured in Nm). In this method, two stationary modes at which the particulate matter generation is high (particulate matter concentration in the exhaust gases above 30% of the maximum concentration condition of the engine, with an injector used above 60 h) and at the same time the engine is thermally stable and moderately loaded (below 65% of the maximum load) are chosen. These conditions decrease the time necessary to achieve a high mass of deposits on the injectors. To reinforce the necessity of specific developments around the problem of injector fouling in GDI engines, this methodology has achieved a selection of stationary point/s (when the thermal conditions of the engine are stable) which create high injector fouling positioned very close to normal driving conditions in highways. Thus, injector fouling takes place in usual conditions and points out the relevance of this methodology allowing development processes being evaluated in a working day.

Due to the influence of the particulate matter concentration inside the cylinder chamber in the injector fouling process, the particulate emission analysing equipment 40 is necessary to select the critical point or points (of high particulate matter concentration and moderate thermal load) to achieve enough mass of deposits in the injector holes along the test which disturb the injector optimal performance. Then the duration of the test can be optimized.

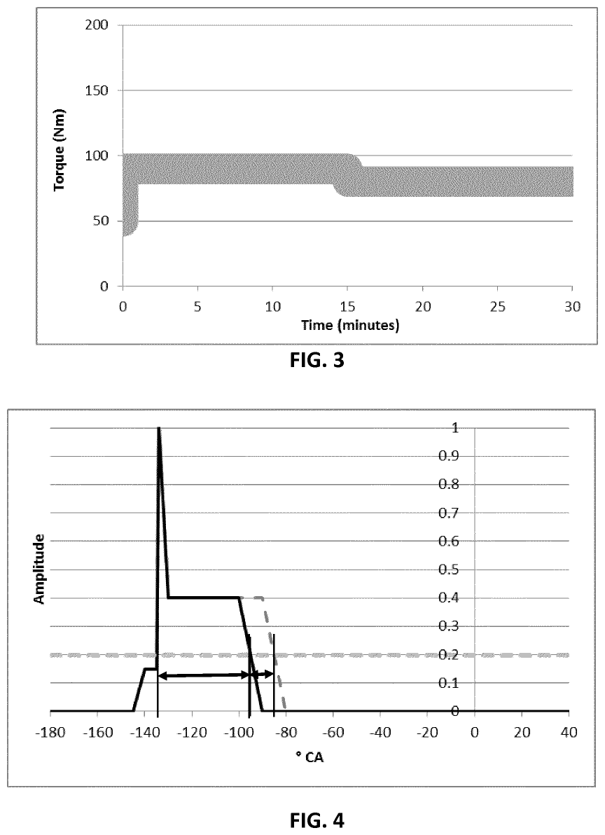

Once these two engine conditions at which injector fouling takes place rapidly have been determined, an engine cycle is defined by concatenating phases of these modes with duration of more than 1 minute, preferably 15 minutes, as shown in FIGS. 2 and 3, creating a succession of stationary points.

As it can be seen in FIGS. 2 and 3, in the preferred embodiment the engine cycle is formed by two engine modes, each mode setting the engine to operate at an engine speed and an engine load which are between 35% and 65% of their range. The cycle starts with the engine mode having the higher load during 15 minutes, and then the engine mode is changed to the engine mode having the lower load during another 15 minutes. This process is repeated twelve times to a total of 6 hours.

In the particular case of the EA111 engine, the worst engine modes chosen are 3300 rpm and 90 Nm, and 3000 rpm and 80 Nm (see FIGS. 2 and 3).

The test bed also includes temperature and pressure sensors at different points of the engine so as to monitor and register throughout each engine cycle the main engine parameters—pressures and temperatures—to ensure that the engine has been operating correctly during the engine cycle. This fact has special relevance to ensure the repeatability and reproducibility of the methodology developed. These parameters provide information about the thermal stabilization of the engine to start the fouling cycle, and also provide information about abnormal measured points; this allows for discarding erratic fluctuation of the engine if the ECU is applying corrections, thereby increasing the precision of the measurements.

Additionally, particulate matter emissions and injection duration are continuously registered to evaluate the evolution of injector fouling. This evolution can be seen in FIG. 4, which shows the difference in the injection pulse duration during a test cycle of a clean injector (represented by the black solid line) and the increase in the duration of the injection pulse when the injector is fouled (represented by the dotted line): an increase of around 10 ° CA can be seen.

This methodology enables the comparison of the effect of fuel formulation and the effectiveness of DCA on injector fouling in a relatively short period of time of just 6 hours, while other methods for evaluating injector fouling require a minimum time around 30 hours.

The procedure of injector fouling described above can also be used to evaluate the effect of additives both on the keep-clean and clean-up processes. It may also be used to evaluate the deposition of the unburned combustion products on the injector.

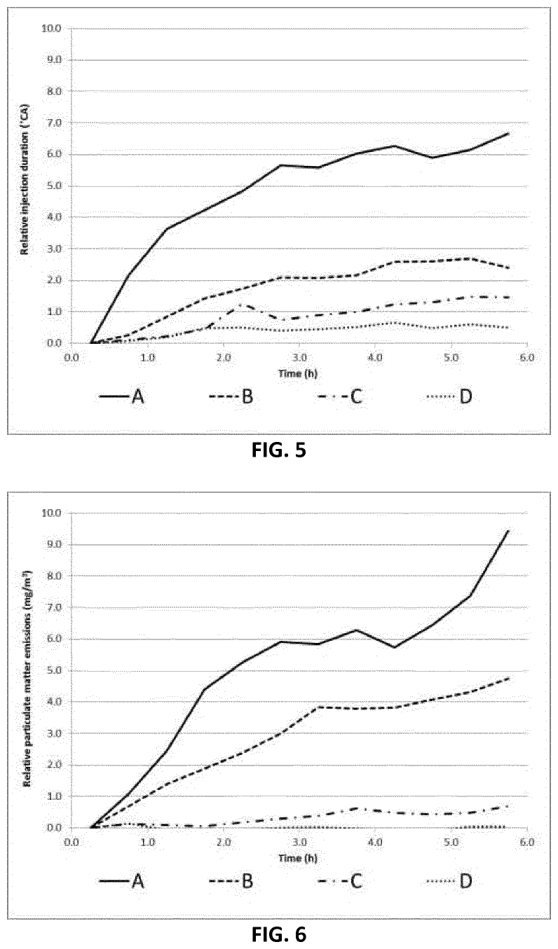

As an example the evolution of the injection duration using four different fuel formulations A, B, C and D in the test cycle is shown in FIG. 5. Formulation A contains no additives; formulation B contains a certain amount of additives; formulation C contains a higher amount of additives than formulation B; and finally, formulation D contains a higher amount of the same additive than formulations B and C. FIG. 6 schematically shows the evolution of particulate matter emissions also using the same four different formulations A, B, C and D in the test cycle. It is apparent that, with the method disclosed in the present disclosure, the effect of the different additives and their concentration in the total formulation of the gasoline can be evaluated in just 6 hours.

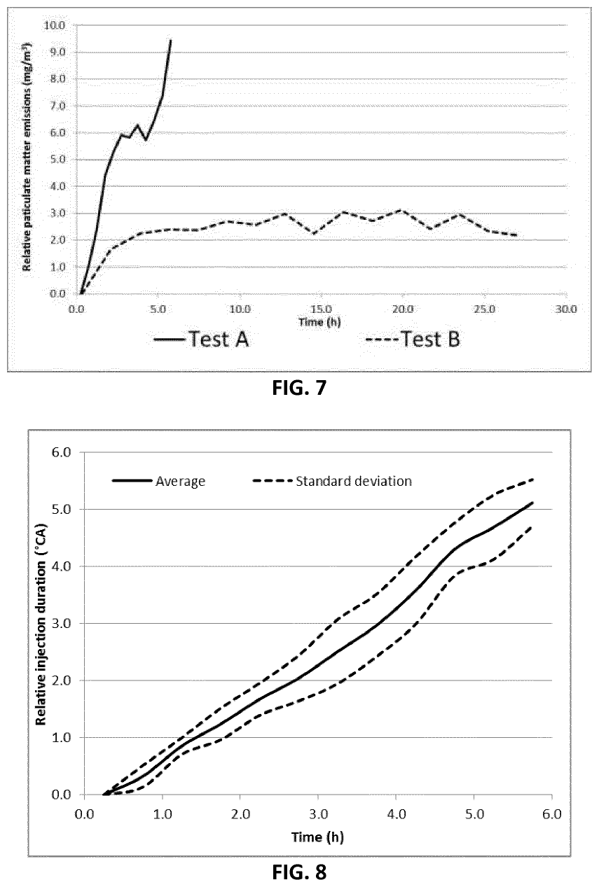

FIG. 7 shows a graphical comparison of the 6-hour fouling test according to the disclosure and a non-accelerated 29-hour test in terms of particulate emission.

The non-accelerated 29-hour test is based on the methodology used to study the effect of fuel on fouling processes over intake valves in port fuel injector engines. This methodology is based on alternating the engine operation very rapidly (in terms of seconds) between low, medium and high engine regimes and loads. This test repeats the cycle shown in the following Table 1 until the end of the test. It is apparent that the 6-hour test, whose engine conditions have been defined on the basis of their particulate matter emissions, is more severe than the 29-hour test based on another methodology.

TABLE 1
Description of 29 hours test of GDI injector
fouling based on another methodology.

| | Engine speed (rpm) | Torque (Nm) | Time (s) |
|---|---|---|---|
| Mode 1 | 1000 | 30 | 25 |
| Mode 2 | 1300 | 30 | 15 |
| Mode 3 | 3000 | 92 | 10 |
| Mode 4 | 5000 | 130 | 10 |

To evaluate the repeatability of the method for accelerated fouling of the present disclosure, the test was repeated seven times using the same fuel. A commercial fuel without any additive was selected, since it provides the worst conditions to accelerate injector fouling, and also the worst statistical condition, because of its higher deposit concentration and the higher dispersion deposition. FIG. 8 shows the results thereof: the standard deviation of the injector duration increases as the injector duration increases. The standard deviation in this test varied between 0.15 and 0.59 crank angle degrees as injection duration increased during the test.

The precision of the method of the present disclosure enables the evaluation of different fuel formulations, or the use of fuel additives, or other engine modifications (for example, different injector designs) as shown in FIGS. 5, 6 and 8.

On the other hand, the disclosure is obviously not limited to the specific embodiments described herein, but also encompasses any variations that may be considered by any person skilled in the art (for example, as regards the choice of materials, dimensions, components, configuration, etc.), within the general scope of the disclosure as defined in the claims.

1. A Method for fouling an injector of a gasoline direct injection engine, which comprises:
operating the direct injection engine on at least a first stationary engine mode which is defined by a pre-established engine load and a pre-established engine speed, both the pre-established engine load and speed being comprised within 35% and 65% of their maximum values, this at least first stationary engine mode being characterized by high particulate matter generation with a concentration of particulate matter in exhaust gases which is above 30% of the maximum concentration of particulate matter of the engine in the exhaust gases;
wherein the direct injection engine is operated on the at least first engine mode for less than ten hours.

2. The method according to claim 1, wherein operating the direct injection engine comprises alternating operation of the direct injection engine between a first stationary engine mode and a second stationary engine mode, each engine mode being defined by a pre-established engine load and a pre-established engine speed, both the pre-established engine load and speed being comprised within 35% and 65% of their maximum values and being characterized by high particulate matter generation.

3. The method according to claim 2, wherein the GDI engine starts operating at the engine mode having the highest engine load.

4. The method according to claim 2, which further comprises continuously monitoring the particulate matter emission.

5. The method according to claim 1, which further comprises continuously monitoring the injection duration of the injector using external current or voltage measuring means.

6. The method according to claim 1, wherein the direct injection engine is operated for less than eight hours, preferably during six hours.

7. The method according to claim 2, wherein the direct injection engine is operated in the first stationary engine mode and in the second stationary engine mode during time intervals of the same duration.

8. The method according to claim 2, wherein the first stationary engine mode and in the stationary second engine mode are operated during time intervals, each time interval having a duration of at least 1 minute, preferably of 15 minutes.

9. The method according to claim 1, which further comprises continuously monitoring temperature and pressure at pre-established points of the engine.

10. The method according to claim 1, which further comprises:
a) determining a maximum concentration of particulate matter of the gasoline direct injection engine in exhaust gases; and
b) establishing high particulate matter generation as a concentration of particulate matter in the exhaust gases that is above a 30% of the maximum concentration of particulate matter determined in step a).

11. The method for evaluating the fouling effect of a gasoline formulation in a gasoline direct injection engine, which comprises using the method for fouling an injector of any of the previous claim 1 and operating the gasoline direct injection engine with such gasoline formulation.

12. The method according to claim 11, wherein the gasoline formulation includes a deposit control additive, and the performance of the deposit control additive is evaluated.

13. The method for evaluating an effect of an engine parameter of a gasoline direct injection engine, which comprises using the method for fouling an injector of claim 1 and operating the gasoline direct injection engine with different values of that engine parameter.

14. The method for evaluating an effect of an engine component of a gasoline direct injection engine, which comprises using the method for fouling an injector of claim 1 and operating the gasoline direct injection engine with different designs of the engine component.

15. The method according to claim 14, wherein the engine component is an injector.
